(19) United States
(12) Patent Application Publication
(10) Pub. No.: US 2004/0180708 A1
(43) Pub. Date: Sep. 16, 2004

(54) Health based internet game for children

(76) Inventors: Barbara Helen Southard, Floyd, VA (US); Douglas Ralph Southard, Floyd, VA (US)

Correspondence Address: THE TECHNOLOGY LAW OFFICES OF VIRGINIA, P.O. Box 818, Middleburg, VA, 20118, US

(21) Appl. No.: 10/390,068

(22) Filed: Mar. 14, 2003

(51) Int. Cl. A63F 13/00

(52) U.S. Cl. 463/1

(57) ABSTRACT

An Internet-based program for children from nine to eleven years old which has as its goal the prevention and/or treatment of childhood obesity from an early age. The program can take the form of an adventure game in which the player must distinguish him or herself from the other lethargic humans by gaining energy units from a physical activity sensor, by answering questions correctly and/or by parental I input.

This invention relates to an Internet data-based program for children from approximately nine years old to eleven years old with the goal of preventing and/or treating childhood obesity. It takes the form of an adventure game in which the hero, the player, has physical abilities in a world where all other people have lost their physical characteristics and perform tasks only with robots and machines. To succeed in the game a youthful player must gain units of energy from either a physical activity sensor, answering health questions correctly or from input by their parents as to how healthy their behavior has been recently.

### BACKGROUND OF THE INVENTION

Children today, as studies have shown, are increasingly overweight due to habits that start when they are young in response to an environment that promotes routines and eating patterns which, in the long run, are injurious to their health. Seventy percent of homes in the country have electronic game systems, and children spend an average of one and a half hours playing interactive games each day. These home PCs are capable of running fairly sophisticated programs including those with interactive programs that one can use for learning. These games are compelling to those in the 9 to 11 year old age group, and a child will enter into subject areas within a game framework that he or she would not normally discuss or participate in. In other words, the program is “safe territory” where children can freely play and explore without censure of adults or peers. Such a system can be used to introduce and then reinforce healthy lifestyles to young children who readily accept such information.

The instant invention centers around a game which takes the form of an Internet program for preventing and/or treating childhood obesity in children from about 9 to 11 years of age, although the program can be used for younger or older children depending on their development and learning abilities. The program has both a child interface and a parental interface.

Both parent and child use passwords to access the sites. Playing instructions are linked to the login screen and include an explanation that explains to the child that in order to obtain units of energy to play the game the user must have a parent enter information into a form, answer health questions correctly, or exercise so that a body sensor relates activity to the database. Generally, a pedometer is used to measure body activity of the child. The child is then given the story line which essentially informs the child that he or she is the only person in the land with physical abilities to perform certain tasks necessary to get all the world's energy back from an evil-doer who has stolen it from the world. The people in this world are weak due to inactivity and hence are helpless without power.

The child then proceeds through various scenes on the monitor in which there are challenges. He or she has to successfully complete the challenges to obtain items for a backpack which, when filled with all the necessary components, will allow him or her to combat the evil-doer and retrieve the world's energy. As the child proceeds with the play, the number of energy units (called “ergs” in the game) is always displayed so that he or she can keep track and use energy efficiently. A library screen allows the player to complete a questionnaire on nutrition and exercise. If all the questions are answered correctly the player gains more energy units to play the game. This process continues until the user has items necessary to meet the final challenge of dismantling the evil-doer's device used to rob the world of energy. A helpful character aids the child in making selections by providing hints as the play proceeds.

### PRIOR GAMES IN THE HEALTH FIELD

There have been previous attempts to connect healthy activity and computers but none of the prior art has anticipated or rendered obvious the instant invention and its employment.

The multi-player game described in Brown, U.S. Pat. No. 6,210,272, shows an interactive electronic game for health education in which each player manages the health of a game contstruct, such as a character. Each player is rewarded on correct responses, and the program uses a common database. The game is used to teach children about various diseases, such as asthma, diabetes, etc., and health habits, such as dental hygiene and drug use. Improper health behavior by a player negatively affects some of the common resources used by all players. Education about health is obtained by communication between players and correlating their playing results. There is no parent involved in changing and updating the database, nor is there just one player. There is no decision making relating to use of the playing units or challenges met to proceed to a final goal. Additionally, there is no relationship between the child's real activity and energy units to play the game.

In U.S. Pat. No. Re 34,728, there is shown and described a one-player video game in which the difficulty of the play is affected by the amount of physical input of the player, which is sensed and then input to the program to make play more difficult once physical activity drops off. The device measures heart rate or speed of an exercise machine. Again, there is no parental input or gathering of items to achieve a final goal. The child's activity, when not connected, is not related to the game play.

U.S. Pat. No. 6,227,974 B 1, to Ellat et al, shows a video game in which a player creates an avatar of her or himself using a headband sensor which monitors her or him during play. The system allows for play by two players as well, and the avatars of both are manipulated by the players in the game. The child must be connected by the headband sensor during play, and activity performed during the day while not wearing the headband in close proximity to the computer is not related to the game.

A tilt sensor shows a player inputting a video program in U.S. Pat. No. 4,925,189, to Braeunig, in which the player moves his upper body in any direction to utilize the back, abdominal and lateral muscles as inputs as well, as hand controls. Again, there is no relationship of the game to activity when not connected to the game controller.

Harada et al, in U.S. Pat. No. 6,213,872, shows a game in which a pedometer is used by a player to alter the display state of a character on the screen. The primary purpose of the game is to affect children's health habits while allowing the child to select one program from many in the database and to display it. This game is not an adventure game and it does not require energy units to solve challenges or collect items needed to defeat an evildoer. The child's activity during the day is not related to energy units needed to play the game.

The U.S. Pat. No. 4,720,789, to Hector et al, shows a video game based on an exercise system using a plurality of foot positions on sensors to interface with the program. This system does not relate to a child's activity throughout the day.

U.S. Pat. No. 5,362,069, to Hall-Tipping, shows a video game operated as an exercise device, such as a bicycle, which, like in Re 34,728, described above, makes the difficulty of the play higher the more physical activity lessens. Thus, the player is encouraged to input higher energy levels. This game is very dissimilar to the instant invention.

The exercise cycle in U.S. Pat. No. 4,298,893, shows a simple device which turns a TV on and off depending on the level of activity. Likewise, U.S. Pat. No. 6,376,936, to Thomas, shows a similar device. This system has none of the complexity of the instant invention and is a simple on/off operation.

Thus, it is seen that none of the prior art devices involving exercise and a video game even approach the conceptual level of the instant invention let alone the physical and operating characteristics of the instant invention. The instant game has two inputs, one player, a varied source of playing units and a final goal. Furthermore, the player is not connected to the game to measure activity. Rather, activity done throughout the day in relatively distant places is measured by a sensor and input later to gain energy units needed to play the game.

### OBJECTS OF THE INVENTION

Accordingly, it is an object of the invention to provide an Internet program that is geared to preventing and/or treating childhood obesity in children of the middle years.

It is another object of this invention to provide a program which consists of a game and has a Parent interface and a Child interface. The Parent interface allows parents to input information that can be transformed into energy units for the child to play the game.

It is still another object of this invention to provide an on-line adventure game by which children learn about healthy habits and reach a goal at the end of the game. E-mail reminders are sent to parents asking them to complete the checklist, these e-mails include education tips to help encourage their child to choose healthy foods and stay active.

Another object of this invention is to provide an on-line adventure game in which a child gains energy units to play the game through input from his parent(s), from actual physical activity and from answering health-related questions correctly. These units are used to progress through the game to a final goal, and

Yet another object of this invention is to provide an Internet game by which children learn and are reinforced in healthy habits and attitudes and in which he or she acquires various tools necessary to complete the game and achieve the goal, and

Still another object of this invention is to provide an Internet game in which a child user plays a game in which he or she may get additional playing tools by the game referencing inputs from his or her parents, and

These and other objects will be seen when reference is had to the accompanying text and drawings in which:

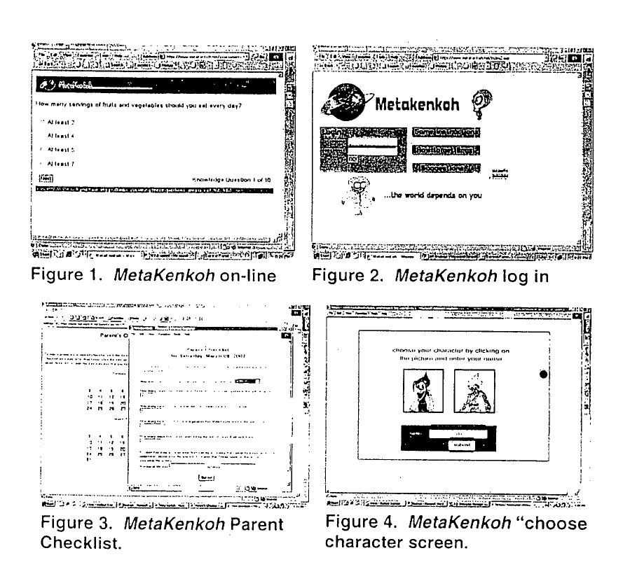

FIG. 1 is a screen representation of a game questionnaire.

FIG. 2 is a screen showing a playing log.

FIG. 3 is a screen showing a parent checklist.

FIG. 4 is a screen with a “choose character” showing.

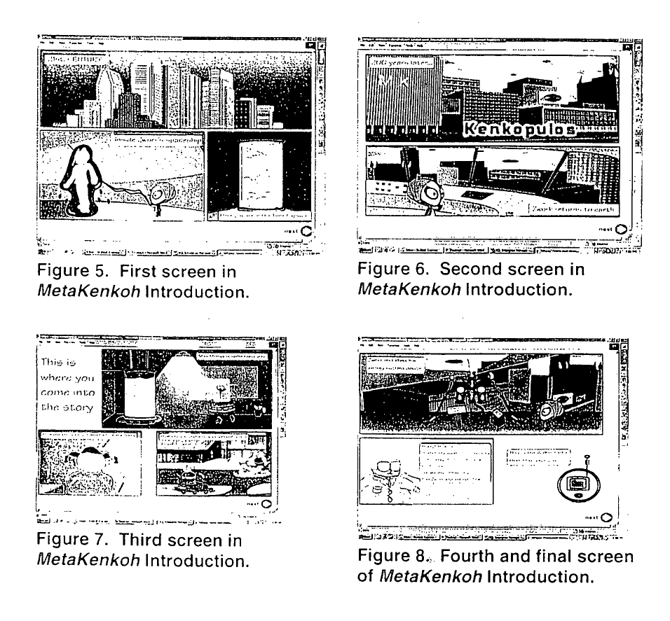

FIG. 5 is the first screen in the introduction to the game.

FIG. 6 is a second screen in the game introduction.

FIG. 7 is the third screen in the game introduction.

FIG. 8 is the fourth and final screen in the introduction.

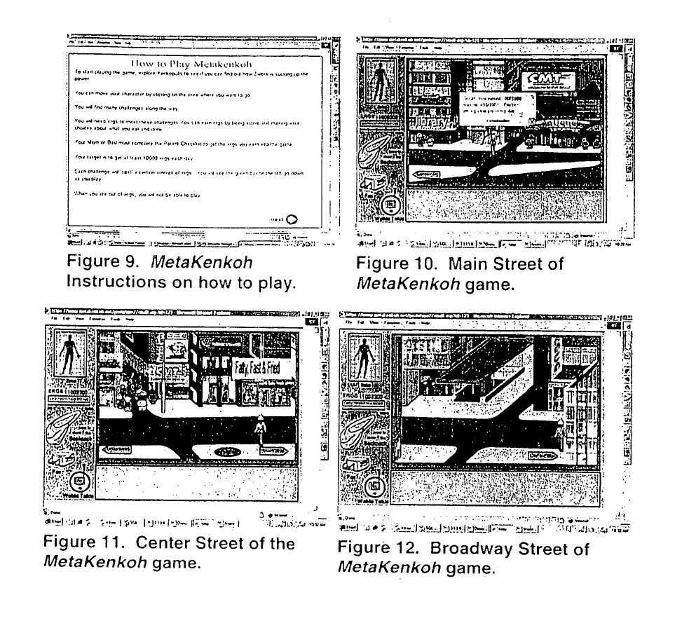

FIG. 9 is a screen with the playing instructions.

FIG. 10 is a screen with the Main Street representation.

FIG. 11 is a screen with the Center Street representation.

FIG. 12 is a screen with the Broadway Street representation.

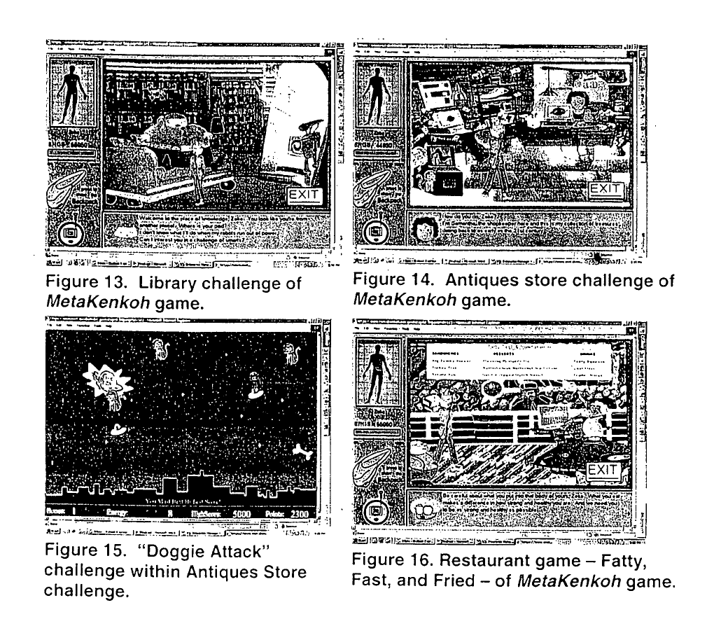

FIG. 13 is a screen showing the Library challenge.

FIG. 14 is a screen showing the antiques store challenge.

FIG. 15 is a screen showing the Doggie Attack challenge.

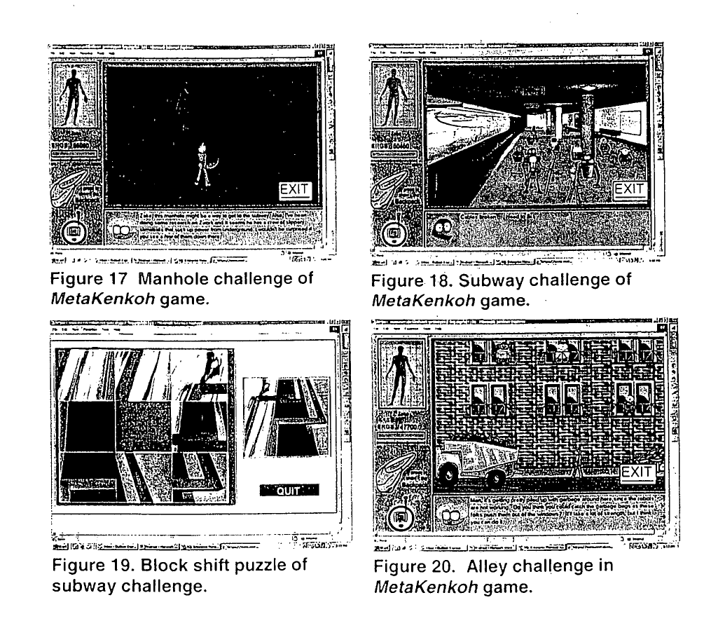

FIG. 16 is a screen showing the restaurant game.

FIG. 17 is a screen showing the manhole challenge.

FIG. 18 is a screen showing the subway challenge.

FIG. 19 is a screen showing the block shift puzzle.

FIG. 20 is a screen showing the Alley challenge.

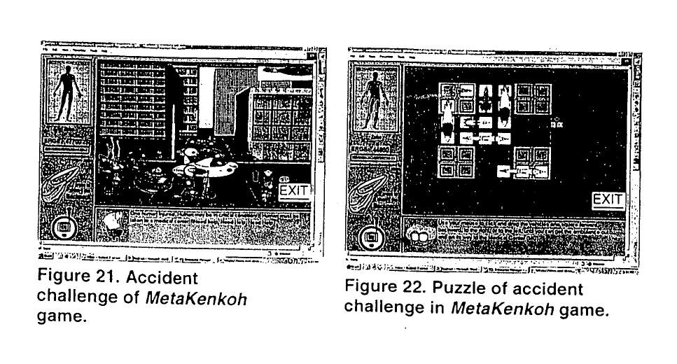

FIG. 21 is a screen showing the Accident challenge

FIG. 22 is a screen showing the puzzle of the Accident challenge.

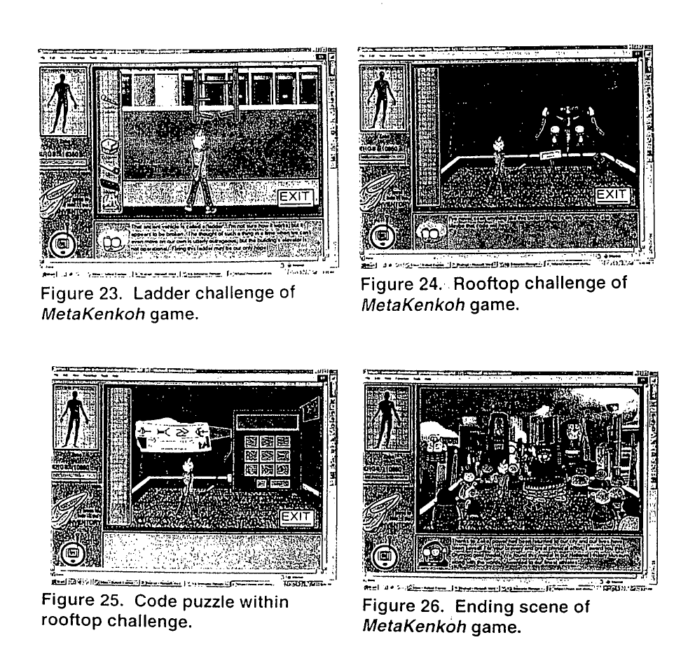

FIG. 23 is a screen showing the Ladder challenge.

FIG. 24 is a screen showing the Rooftop challenge.

FIG. 25 is a screen showing the code puzzle with the rooftop challenge.

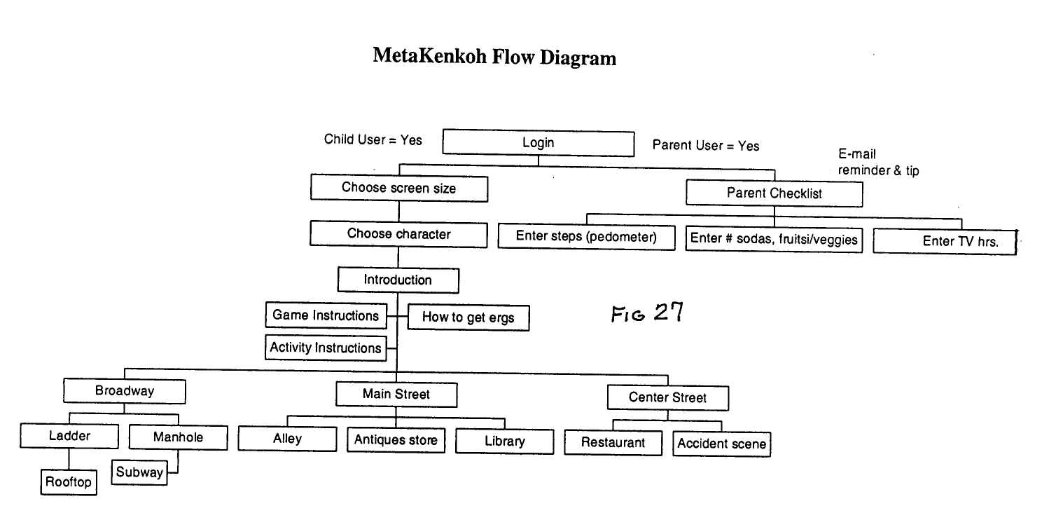

FIG. 26 is a screen showing the ending scene of the game.

FIG. 27 is a flow diagram of the game play.

In playing the game both parent and child are users who may complete on-line questionnaires (example screen displayed in FIG. 1) on entry and exit. The entry questionnaire consists of a 10-item multiple-choice questionnaire and a brief attitudes survey. On exit they complete the same questionnaire, plus a satisfaction survey. This questionnaire is optional and does not have to be employed. Some contact information through e-mail is clearly necessary, however.

Both parents and children choose usernames and passwords on entry into the program. These are not absolutely necessary but may be used. They are not integral to the game. On the first login, all users are asked to change their passwords. These passwords are then encrypted in the SQL database, and users are required to use these passwords in order to access the site. If a user forgets his or her password, they are asked to call or e-mail the providers of the on-line game to obtain a new password which they then change at first login. This is to provide security against anyone else, including the provider's employees, learning of the password. Only the user can know the password. The login screen (displayed in FIG. 2) also provides a link to instructions on how to play the game, activity suggestions, and information on how to get “ergs”, or units of play. The exit screen also provides a link to the activity suggestions and “How to Get Ergs” screen.

When parents of the child log onto the program they go directly to the Parent Checklist (displayed in FIG. 2) where they answer questions daily about their child's behavior during the past 24 hours, including hours of TV watched, hours of video/computer games played, numbers of cans of soda they drank, number of servings of fruits and vegetables they ate/drank, number of steps measured be pedometer, and number of minutes of activities not measured by a pedometer which the child uses to input the program. Alternatively, exercise data can be automatically uploaded to the program database using more sophisticated sensors, such as an armband which is placed into a cradle attached to the user's PC with the appropriate software.

At the onset of the program, the providers of the game e-mail parents forms with spaces to write down the number of steps and other pertinent information in the event parents are not near a computer at days end. Using the forms, parents are able to reset the pedometer for the next day without fear of losing or forgetting important data. This is an optional procedure and once done, is not repeated. The forms are a download or printout.

Parents can complete checklists for previous days, as well, by clicking on the date on the calendar displayed in a separate window beside the Parent Checklist (see FIG. 3). E-mail reminders are sent daily to help parents remember to complete the checklist. Brief tips about how parents encourage their children to eat healthy foods and to be more active.

Children are asked to choose a character and name for their character, as well as a screen size for display, as in FIG. 4. Once the user has chosen a character and size of screen, the Introduction to the game is displayed (See FIG. 5, 6, 7 and 8). The Introduction includes Flash animation and a brief audio description of the story and goal of the program game. What follows is a synopsis of the story line presented to the child.

Back in the 21^{st} Century the user was frozen by an alien named Zwork who was on earth to steal energy. Zwork decided that there wasen't enough energy to bother stealing from the earth then, but because Zwork found earthlings' method of using their own energy to do things (rather than using robots and machines exclusively as on his planet), he decided to freeze a specimen. He intended to pick the specimen up on his way back home after stealing power from another more energy-rich planet.

When Zwork returns to earth centuries later for his frozen specimen, it has disappeared. The frozen 21^{st} Century human (the user) had been recently discovered and sent to a laboratory to be unfrozen and studied by Max Mensa, the planet's Chief Top Secret Scientist. During this futuristic time, earthlings do not walk or do any tasks requiring the least bit of energy.

When Zwork decides to steal the earth's power, now that Earth is generating a sufficient amount, the people are left in a very weakened condition. They lack the strength, skill and ability to do even the simplest tasks. Their robots and other power-driven machines malfunction as the power gradually is sucked up by Zwork. However, luckily for the earth's people, the user, being from the 21^{st} Century, still maintains strength and ability to do manual tasks.

The user becomes the hope of the people. They believe that this strange ancient human might be able to stop Zwork and return power to the planet. Max encourages the users to learn about nutrition and exercise and begin to get back the strength and health (after being frozen for so long) to help them fight Zwork.

Following the Introduction, a screen with instructions on how to play the game is displayed (FIG. 9). The Introduction is shown only once. Instructions can be viewed at any time from a link on the login screen.

Following the instructions screen, the user's character is displayed on Main Street (as shown in FIG. 10). When the user first enters, there is a small white window that provides feedback on how many ergs (from the Parent checklist) he or she has earned the day before.

The target number of ergs for each child is calculated by multiplying the average number of steps during the week before playing the game (baseline) by a factor of 1:1 if the average number of steps was greater than 10,000; 1:3 is less than 10,000; and 1:5 if less than 5,000. If there is no baseline, the ratio is 1:1. If the child earns less than the target in the previous day, the program encourages the user to achieve the target number or ergs, and if the child achieves or exceeds his or her target, the program displays a message indicating this. If there are no ergs reported for the previous day, the feedback screen indicates this and asks the user if he or she would like to print a reminder for their Mom or Dad. The printed reminder includes a message to the parent encouraging him or her to complete the Parent Checklist daily.

The user can then go to the other two street scenes (See FIGS. 11 and 12) or to the areas in which there are challenges, including the Library (FIG. 13), Antiques Store (FIG. 14), Fatty, Fast and Fried Restaurant (FIG. 15), Manhole (FIG. 16), Subway (FIG. 17), Alley (FIG. 18), Accident (FIG. 19), Ladder (FIG. 20), or the Rooftop (FIG. 21).

The number of ergs the user has accumulated from the Parent Checklist minus ergs used during play is displayed above the green “erg bar” on the upper left-hand side of the screen (see FIG. 10). The “body status” in the upper left-hand side of the screen changes with activities of the character to indicate body parts that are being used. For example, the muscles of the legs flash as the character walks through the streets. Clicking on the “backpack” brings up a list of items the character has collected after each challenge has been completed (See FIG. 11). When the “walkie-talkie” is flashing, the user can click on it to receive hints from Max about how to go about completing various challenges. The “fax” flashes when the user completes each challenge and at the end of the game to indicate that there is a MaxFax (i.e., a “congratulations on completing the challenge” message) for the user to print.

The green or large empty space at the bottom of the screen is used to display dialogue text, alongside a thumbnail graphic of the character's animated face (see FIGS. 13-21). At the top of the screen there are links to Options—where users can change their character and name, Help—where users can view roll-over text boxes for each component of the screen (i.e., body status, erg bar, backpack, etc.), and Exit Game, where users can click to exit the game and go to links on how to get ergs and suggested activities to get ergs.

At each of the “challenges”, the user encounters a game which he or she is required to complete in order to obtain the seven backpack items needed to stop Zwork. Each challenge “costs” a certain number of energy units, or ergs, which are calculated based upon the child's daily target ergs. (i.e., 25% of target, 50% of target).

At the Library (see FIG. 13), users complete a 5-question multiple choice test of nutrition and exercises. The five questions are randomly generated from a pool of questions available, so that each time the user goes to the Library there are five different questions. If the user answers all the questions correct, they get energy credits. In the Library users also have access to “Data Tapes” on a variety of topics related to diet and exercise, including”

Fruit Copycats

Nutrition Facts and Myths

Diet & Exercise Myths

What are Calories

The Truth about Fad Diets

Exercise Tips

Aerobic Exercise

Healthy Snacks, and

Health Facts.

The Library rewards the user with ergs when he or she answers all the questions correctly.

At the Antiques Store, (see FIG. 14), the user is required to beat the highest score on an old, antique video game called “Doggie Attack” (see FIG. 15), which is a typical shooting-style game. The Antiques dealer rewards the user with a box of nails when the user beats the highest score on Doggie Attack.

At the Restaurant (see FIG. 16), the user is required to choose the healthiest options from the menu. The user collects a “booster seat” after ordering the correct option.

At the Manhole (see FIG. 7), using his or her laser guide (from the Library), the user is required to find and neutralize “slime” creatures that are helping Zwork suck up power. After finding and neutralizing the slimes, the program displays an animation of Zwork escaping the manhole and accidentely dropping a piece of paper. The user is advised by Max to collect the piece of paper, which turns out to be an important code-key needed to dismantle the power-sucking device on the rooftop.

In the Subway, (see FIG. 18), the user is required to fix the train cables before the train arrives. The user is presented with a block-shift puzzle (see FIG. 19) of the cables to complete this challenge. A robot rewards the user with an old hammer when he or she fixes the cables.

At the Alley, (see FIG. 20), the user is asked to help the people in the apartments by “catching” their garbage bags. The more bags hit the ground (without being caught), the higher the user's “dirt meter” becomes. The user is required to achieve “level 3” to complete this challenge. At the end of this challenge, the user is asked to pick up an old rusty saw, which becomes an important tool later in repairing the ladder in the game.

At the Accident challenge (See FIG. 21), the user is required to move the vehicles out of the way of the ambulance to allow the rescuer worker to get to the Medical Center with his injured patients. To accomplish this, the user has to complete a block-shift puzzle (FIG. 22). On completion, the user collects boards from a street sign that has broken during the accident, items which are later needed to repair the ladder.

To enter the ladder challenge (See FIG. 23), the user is required to have all seven items in his or her backpack. All except the code-key were used to repair the ladder and ascend to the rooftop. On the rooftop (see FIG. 24), the final challenge, the user dismantles Zwork's power-sucking device using the code-key (See FIG. 25).

After dismantling the power-sucking device, the user is presented with an Olympic gold medal (an artifact found in a museum) for stopping Zwork and saving the planet (See FIG. 26). The user is also credited with starting a new trend among young people of “walking on their own”.

Throughout the game, Max (via walkie-talkie) provides hints at each challenge on how to go about completing the challenge and what items should be collected for the backpack.

Each challenge “costs” the user ergs, with the exception of the Library, which is “free”. The cost of each challenge (other than the Library) is between 10% and 50% of their target ergs for the day. As mentioned previously, the target ergs are individualized based upon the average number of steps taken during the baseline week. Thus, the cost of each challenge is individualized depending upon the activity level prior to starting the game.

The user can then go back and repeat games previously completed. However, after thirty minutes the game times-out and the user receives a message that it is “time to go out and earn some ergs”.

FIG. 27 shows the system flow chart with the various options. As shown, the player logs in, whether it be the child or parent. If it is the parent, upon logging in the program displays the parent checklist. This checklist includes questions regarding pedometer steps, number of sodas, fruits, etc. ingested and the number of TV hours viewed. An e-mail is also sent to the parent as a reminder to complete the parent checklist, along with a tip on how to help his/her child eat healthier, be more active, and/or manage weight. If it is the child, upon logging in the program displays a screen to allow the child to choose a screen size, and a character. The child is then presented with the introduction, which includes information on how to obtain ergs, as well as the game and activity instructions.

The child then proceeds through the three main areas of Broadway, Main Street and Center Street playing as directed to obtain ergs or other information or aids to assist him or her in proceeding. While the specific locations are labeled as Ladder, Alley, Restaurant, etc., it is understood that variations of these locations can be used, the purpose being to make the child perform certain tasks and to retrieve backpack items, additional ergs, and/or information to enable him or her to complete the game. Thus, the actual locations can be made graphically to look like other scenes or locations, the number of which is infinite. The locations are tasks that the player must accomplish successfully to finish the game. His or her health habits, if proper, will be a big assist to the player and that recognition will become apparent to the player as he or she progresses through the game and subsequent games.

Having described the preferred embodiment of the game, it will be obvious to those of ordinary skill in the art to make changes and modifications to the game and method of use without departing from the scope of the appended claims.

What is claimed is:

1. A method of teaching/reinforcing good health habits using an interactive, Internet based adventure game program, said method comprising
a) Setting the interactive game objective in said program database,
b) Inputting information relative to said player into the database,
c) Providing information to said database related to physical and health activity of said player, said information being provided by a person other than the player of the game,
d) Providing said player with playing units to enable him or her to play the game and continue so as to complete the game successfully.

2. A method as in claim 1 wherein said player is a child and said other person is an adult responsible for said child.

3. A method as in claim 1 wherein said information provided to said program database is related to said player's health behavior in terms of ingested food, activity levels, exercise periods and other health information over a predetermined period of time.

4. A method as in claim 1 wherein said player is provided with playing units by visiting a source of such units and successfully answering questions related to health issues.

5. A method as in claim 4 wherein said challenges are represented by a story line and allow the player to gain either items or energy units or “ergs” to complete the game by overcoming each challenge.

6. A method as in claim 5 wherein said story line presents the player with the task of reaching a final objective related to health by overcoming each of said challenges and gaining additional units to move forward in the game, complete the game and/or win the game,

7. A method as in claim 6 wherein each challenge is a separate game which he or she is required to complete in order to obtain items needed to achieve the overall game goal.

8. A method as in claim 7 wherein one such challenge is a Library where the player is required to answer multiple questions on nutrition and exercise to gain units as opposed to items.

9. A method as in claim 7 wherein one such challenge is a Restaurant where the player is required to choose the healthiest options from the menu and is rewarded with an item needed to complete the game.

10. A method as in claim 7 wherein one such challenge is an underground system where the player is required to neutralize creatures therein and collect a code key which can be used in the final step of the game.

11. A method as in claim 7 wherein one such challenge is a transportation scenario where the player is required to fix train components and is rewarded with an implement which can be used to achieve the final game goal.

12. A method as in claim 7 wherein one challenge is a location wherein the player is required to deal with material found there and is rewarded for successful play by receipt of a second implement.

13. A method as in claim 7 wherein one challenge is an Accident challenge wherein the player is required to move vehicles out of the way of an ambulance and is rewarded by receipt of an item used in the final game play.

14. A method as in claim 7 wherein the second to last challenge involves a Ladder challenge wherein the player repairs a ladder using playing units he or she has obtained through previous successful challenge play.

15. A method as in claim 14 wherein the last challenge involves the player performing a task which ends the game.

16. A method as in claim 1 wherein the other person inputting data into the program database has a checklist provided thereto from which he or she is required to provide daily information thereto relating to the player's behavior related to diet and exercise.

17. A method as in claim 1 wherein the step of providing the player with player units includes having the player exercise during the day while wearing an activity sensor or pedometer in order to acquire playing units.

18. A method as in claim 17 wherein the player exercises with a pedometer to provide playing units based on the amount of exercise the player has performed.

19. A method as in claim 17 wherein said other person provides information relating to the player's level of activity and this information relates to the energy units which are directly proportional to a certain predetermined amount of playing units the player receives at any time during the game.

20. An Internet based game program for children having the goal of preventing and or treating childhood obesity in child players of the game, said program requiring a predetermined amount of playing units, said program comprising
a) An Internet server for providing the game to multiple users,
b) A first interface whereby the child can play the game and obtain playing units to play the game and achieve the end goal,
c) A second interface to allow a parent or responsible adult to input information to said database which relates to the child's recent health related activity and which provides additional playing units directly related to the correctness of said child's activity,

21. A program as in claim 20 wherein the player is connected to an exercise monitoring device which inputs directly into the program database and provides the player with playing units in an amount directly proportional to the amount of exercise being performed by the player, said input occurring while the player is using or wearing the device, not necessarily while playing the game.

22. A program as in claim 20 wherein said program has a database relating health information, and the program is automatically updated as play proceeds.

23. A program as in claim 20 wherein the player can select a character to represent himself or herself during the program play.

24. A program as in claim 23 wherein the program has a storyline and the game has a series of successive challenges, the object of the game being to successfully meet each challenge, collect items needed to complete the game, gather additional playing units and to reach the end of the game and achieve the ultimate goal of the game.

25. A program as in claim 24 wherein one of the challenges is a Subway challenge wherein the player's character has to repair certain items connected with the train to obtain an item to allow him or her to progress with following challenges.

26. A program as in claim 24 wherein one of the challenges is a Library challenge and the player may obtain additional playing units by answering questions correctly.

27. A program as in claim 24 wherein one of the challenges is an Accident challenge wherein the player is required to move vehicles out of the way of an ambulance to obtain additional playing units.

28. A program as in claim 24 wherein one of the challenges is an underground challenge wherein the player is required to combat characters therein to obtain an item useful in later challenges in the game.

29. A program as in claim 24 wherein one of the challenges is a Restaurant challenge wherein the user is required to choose healthy options from a menu and is rewarded when he or she selects the correct option with an item needed to complete the final challenge.

30. A program as in claim 24 wherein one of the challenges is an Alley challenge wherein the player is required to deal with garbage in a correct manner to acquire an item needed to complete the final challenge.

31. A program as in claim 24 wherein one of the challenges is an Antique shop challenge wherein the player must fight off a Doggie Attack to achieve successful play.

32. A program as in claim 24 wherein the second to last challenge is a Ladder challenge where the player must repair the ladder by employing tools received in previous challenge successful play.

33. A program as in claim 24 wherein the number of playing units is adjusted for each player depending on the target set for that player.
